(19) United States
(12) Patent Application Publication
(10) Pub. No.: US 2026/0186369 A1
(43) Pub. Date: Jul. 2, 2026

(54) PHOTONIC MICRO-RING MODULATOR DRIVER

(71) Applicant: Intel Corporation, Santa Clara, CA (US)

(72) Inventors: Wonho Lee, Hillsboro, OR (US); Ganesh Balamurugan, Urbana, IL (US); Cooper Levy, Portland, OR (US)

(21) Appl. No.: 19/002,963

(22) Filed: Dec. 27, 2024

(51) Int. Cl. G02F 1/35

(52) U.S. Cl. CPC G02F 1/3515

(57) ABSTRACT

Some embodiments include apparatuses including a driver with a baseline wander compensation and photocurrent sensing. The driver includes output nodes to couple to terminals of a photonic micro-ring modulator through a first circuit path and a second circuit path. The first circuit path and the second circuit path include unequal numbers of circuit elements.

### BACKGROUND

Micro ring modulators (MRMs) are part of components in silicon photonics devices that converts electrical signals into optical signals. For a relatively high bandwidth (e.g., bandwidth greater than 40 GHz) and high efficiency operation, MRMs are often designed to have both large output swing and reverse bias voltage. Both of these factors can exceed nominal voltages supported by transistors of complementary metal-oxide-semiconductor (CMOS) drivers that drive electrical signals to the MRMs. Further, MRM drivers are often designed to sense low-frequency photocurrent to enable thermal tuning to compensate for process and temperature variations. It is often a challenge to design an MRM driver that is scalable for some processes and meet the speed, drive voltage and control associated with operating specifications for some MRMs.

### BRIEF DESCRIPTION OF THE DRAWINGS

FIG. 1 shows an apparatus including devices, conductive connections, and a driver for a photonic micro-ring modulator, according to some embodiments described herein.

FIG. 2 is a graph showing examples of transfer functions for the driver of a device of FIG. 1, according to some embodiments described herein.

FIG. 3 shows a device of FIG. 1 including details of a compensator (compensator circuit), according to some embodiments described herein.

FIG. 4 and FIG. 5 show example circuits that can substitute a circuit in the compensator of FIG. 3, according to some embodiments described herein.

FIG. 6 shows a device of FIG. 1 including details of a photocurrent sensor (sensor circuit), according to some embodiments described herein.

FIG. 7A shows a device including multiple data lanes that can be a variation of the device of FIG. 1, according to some embodiments described herein.

FIG. 7B shows details of a loop circuit of in the device of FIG. 7A.

FIG. 8 shows a device including feedback-based BLW compensation, according to some embodiments described herein.

FIG. 9 is a flow diagram of an example method of operating an apparatus, according to some embodiments described herein.

FIG. 10 shows a block diagram of an example machine, according to some embodiments described herein.

FIG. 11 a flow diagram of an example process of making an apparatus, according to some embodiments described herein.

### DETAILED DESCRIPTION

The techniques described herein involve a photonic micro-ring modulator (MRM) driver (driver circuit). The driver uses a pseudo-differential AC-coupled high-speed path (high swing and high speed) combined with a DC-coupled low-speed path (high DC voltage). The DC-coupled low-speed path eliminates electrical baseline wander (BLW). The described techniques also include control circuitry to allow gain-matching (e.g., automatic gain-matching) to the high-speed path. The described techniques further include sensing MRM photocurrent from the pseudo-differential driver without using excessively large resistor and bias voltages.

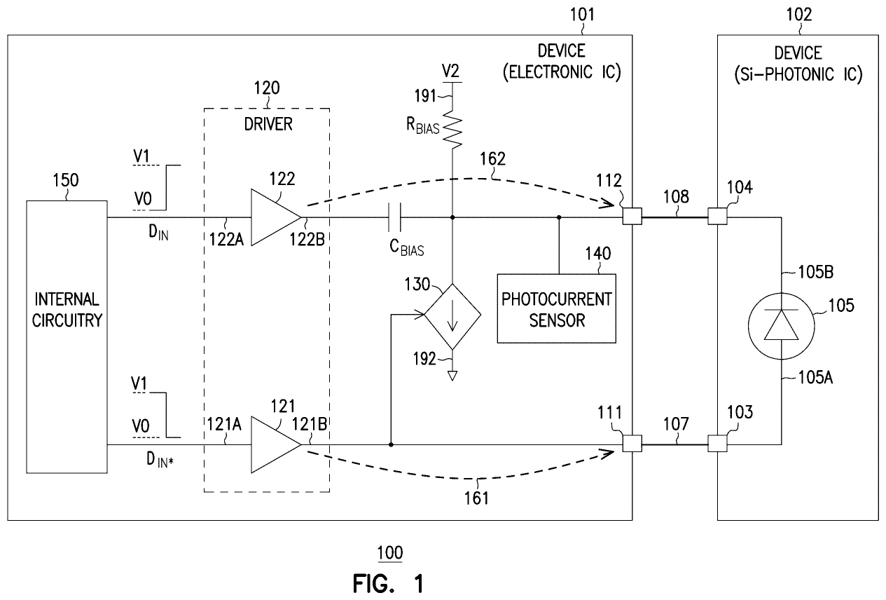

The described techniques provide the benefits of high-bandwidth, high-swing, energy-efficient drivers, plus method for compensating baseline wander. The described techniques can avoid manual tuning of the low-frequency and high-frequency path gains. It also provides a method for photocurrent sensing from the described driver (e.g., a pseudo-differential driver) without using excessively-large DC bias voltages. Other improvements and benefits of the described techniques are discussed below with reference to FIG. 1 through FIG. 11.

FIG. 1 shows an apparatus 100 including devices 101 and 102, conductive connections 107 and 108, and a driver 120, according to some embodiments described herein. Devices 101 and 102 can be part of an optical transmitter of apparatus 100. Apparatus 100 can include or be included (e.g., can be a part of) in a system (e.g., electronic system). Such a system can include or be included in a semiconductor chip (e.g., an integrated circuit (IC) chip), cellphone, a tablet, a computer, a system-on-chip (SoC), system-in-package (SiP), system-on-package (SoP), or other types of electronic systems. For simplicity and to help focus on the techniques described herein, other circuitries of apparatus 100 (e.g., an IC chip, flip-chip, SoC, SiP, or SoP) are omitted from FIG. 1.

As shown in FIG. 1, device 101 can include conductive pads 111 and 112. Device 102 can include conductive pads 103 and 104. Conductive pads 111 and 103 can be coupled to each other through a conductive connection 107. Conductive pads 112 and 104 can be coupled to each other through a conductive connection 108. Conductive connections 107 and 108 can be conductive wires (e.g., metal wires) or other conductive connections. Conductive pads 103, 104, 111, and 112 can be formed from a conductive material (e.g., metal) or a combination of conductive materials. Conductive pads 103, 104, 111, and 112 can include conductive balls, conductive pins, or other forms of conductive terminals of an IC chip, flip-chip, SoC, SiP, or SoP included in apparatus 100. In an example, device 101 and 102 can be located (e.g., co-located) in the same IC package (e.g., a flip-chip package).

Device 101 can include or can be part of an electronic IC (e.g., complementary metal oxide semiconductor (CMOS) EIC). As shown in FIG. 1, device 101 can include internal circuitry 150 to generate data information (e.g., digital data) in the form of electrical signals (e.g., digital input signals) D_{IN} and D_{IN}*. Signal D_{IN} can present a bit of information or multiple bits of information. Signals D_{IN} and D_{IN}* can have complementary values. For example, when signal D_{IN} is at a voltage level corresponding to a binary 1, then signal D_{IN}* is at a voltage level corresponding to a binary 0, and vice versa.

As shown in FIG. 1, each of signals D_{IN} and D_{IN}* has a signal swing between a level corresponding to voltage V0 (e.g., ground) and a level corresponding to a voltage V1. However, as shown in FIG. 1, signals D_{IN} and D_{IN}* swing (switch) in opposite directions between the level corresponding to voltage V0 and the level corresponding to a voltage V1. For example, when signal D_{IN} is at voltage V1 (e.g., corresponding to binary 1), then signal D_{IN}* is at voltage V0 (e.g., corresponding to binary 0), and vice versa. Voltage V1 can be an operating voltage (e.g., Vdd) of device 101.

Device 102 can include or can be part of silicon (Si) photonic integrated circuit (IC). In an example, device 102 and be co-packaged (included in the same IC package) with device 101. As shown in FIG. 1, device 102 can include a micro-ring modulator 105, which operates with other elements (not shown) of device 102 to convert electrical signals (received at conductive pads 111 and 112 (provided by device 101) into optical signals. As shown in FIG. 1, MRM 105 can include a terminal (e.g., anode terminal) 105A and a terminal (e.g., cathode terminal) 105B. Terminals 105A and 105B can be coupled to conductive pads 103 and 104, respectively, of device 102.

Driver 120 of device 101 can be a differential driver that can operate to drive (pass) signals (e.g., input data signals) D_{IN} a D_{IN}* to conductive pads 111 and 112, respectively. Driver 120 can include input nodes 121A and 122A to receive signals D_{IN} and D_{IN}*, respectively. Driver 120 can include output nodes 121B and 122B to provide output signals (not labeled) based on signals D_{IN} and D_{IN}*. Driver 120 can include driver circuits 121 and 122 to receive signals D_{IN}* and D_{IN}, respectively. Each of driver circuits 121 and 122 can include any combination of inverters and buffers to drive a signal (e.g., signal D_{IN} or D_{IN}*) from its input node to its output nodes. Driver circuit 121 can include input and output nodes coupled to input and output nodes 121A and 121B, respectively. Driver circuit 122 can include input and output nodes coupled to input and output nodes 122A and 122B, respectively.

As shown in FIG. 1, device 101 can include a capacitor (e.g., bias capacitor) C_{BIAS} and a resistor (e.g., bias resistor) R_{BIAS}. Capacitor C_{BIAS} includes a capacitor node (e.g., a capacitor plate, not labeled) coupled to output node 122B of driver 120, and a capacitor node (e.g., a capacitor plate, not labeled) coupled to conductive pad 112. Resistor R_{BIAS} is coupled between a node (e.g., bias voltage node) 191 and conductive pad 112. Node 191 can receive a voltage V2, which is a bias voltage associated with terminal 105B of MRM 105. Voltage V2 can be greater the voltage V1. Capacitor C_{BIAS} and resistor R_{BIAS} can form a bias network (R-C network) at conductive pad 112, which is coupled to terminal (e.g., cathode terminal) 105B of MRM 105

As shown in FIG. 1, device 101 can include circuit paths 161 and 162. Circuit path 161 can be configured as a DC-coupled circuit path between output node 121B and conductive path 111, such that output node 121B and can be directly coupled to conductive path 111. Circuit path 162 can be configured as an AC-coupled circuit path between output node 122B and conductive path 112, such that output node 121B and can be coupled to conductive path 112 through capacitor C_{BIAS}.

As shown in FIG. 1, circuit paths 161 and 162 have an unequal number (a different number) of circuit elements. For example, unlike circuit path 162, circuit path 161 may not have a capacitor (e.g., capacitor C_{BIAS}) between node 111B and 112. Thus, circuit path 162 can have more circuit elements (e.g., one circuit element (e.g., capacitor C_{BIAS}) more) than circuit path 161.

Since driver 120 drives the signals at its output nodes 121B and 122B to circuit paths 161 and 162 that have different configurations (e.g. AC and DC configuration), driver 120 can be called an asymmetric differential driver (or pseudo-differential driver). Circuit path 162 can be a relatively high-speed path. Circuit path 161 can be a relatively low-speed path. The combination of an AC-coupled circuit path (e.g., circuit path 162 and the DC-coupled circuit path (e.g., circuit path 161) allows device 101 to reduce or eliminate electrical baseline wander (BLW) and can include control circuitry to allow gain-matching to the AC-coupled circuit path (e.g., circuit path 162).

FIG. 1 shows one data lane (e.g., a differential data lane including driver 102 and circuit paths 161 and 162) between device 101 and 102 for simplicity. However, apparatus 100 can include multiple data lanes (e.g., parallel data lanes coupled to capacitor C_{BIAS}).

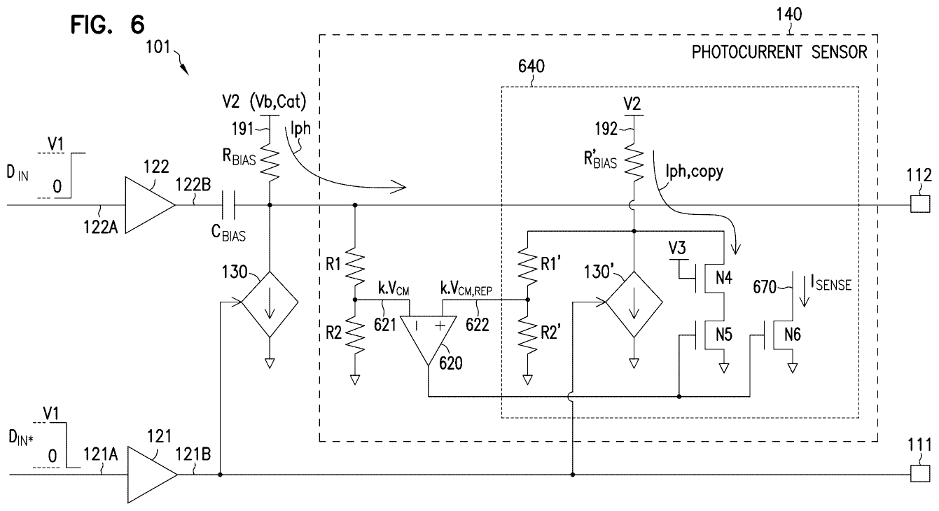

As shown in FIG. 1 device 101 also includes a compensator (compensator circuit) 130 coupled between conductive pad 112 and a supply node 192 (e.g., ground connection) and a photocurrent sensor (photocurrent sensor circuit) 140. As described below, compensator 130 can operate to compensate BLW to improve driver matching network to account for the asymmetric configuration of driver 120 and circuit paths 161 and 162 coupling to MRM 105. Photocurrent sensor 140 can operate to provide a current (e.g., current I_{SENSE} in FIG. 6) based on a current (e.g., current Iph) flowing through resistor R_{BIAS} to conductive pad 112 (which is coupled to terminal 105B of MRM 105). Device 101 can include a thermal control circuit (not shown) that uses current I_{SENSE} to adjust the MRM resonant wavelength.

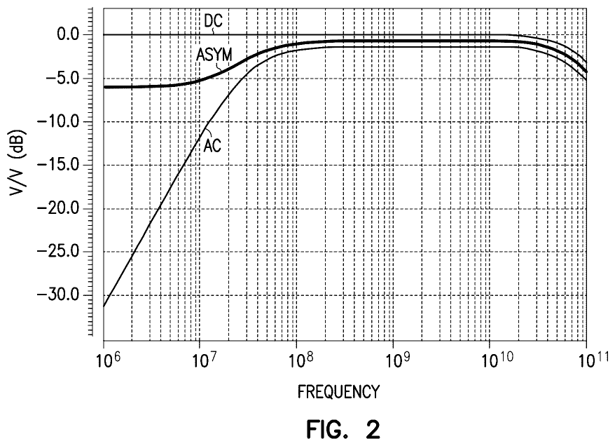

FIG. 2 is a graph showing examples of transfer functions for driver 120 of device 101 of FIG. 1 to MRM 105, according to some embodiments described herein. In FIG. 2, the DC curve (curve labeled “DC”) represents the transfer function for the DC-coupled path (e.g., circuit path 161 in FIG. 1) of driver 120 to terminal 105A (e.g., anode terminal) of MRM 105. The AC curve (curve labeled “AC”) represents the transfer function for the AC-coupled path (e.g., circuit path 162 in FIG. 1) of driver 120 to terminal 105B (e.g., cathode terminal) of MRM 105. The ASYM curve (curve labeled “ASYM”) represents the transfer function for combined AC-coupled path and DC-coupled path of driver 120.

As shown in FIG. 2, the transfer function for the AC-coupled path (e.g., circuit path 162 in FIG. 1) has cut-off frequency around 40 MHz that results in BLW and signal loss due to voltage division between the load (e.g., MRM 105) and capacitor C_{BIAS}. The transfer function for the DC-path (e.g., circuit path 161 in FIG. 1) may not have such a loss (or negligible loss). The DC-coupled path can reduce BLW (e.g., reduce BLW by one-half) and signal loss, as shown by the asymmetric differential transfer function (the transfer function for the combined AC-coupled path and DC-coupled path of driver 120).

The MRM driver configuration (e.g., driver 120 and circuit paths 161 and 162) as shown in FIG. 1 can improve the overall signal transfer function for driver 120. The MRM driver configuration (e.g., asymmetric configuration of driver 120 and circuit paths 161 and 162 coupling to MRM 105) of FIG. 1 can also simplify the design of MRM driver configuration compared with an alternative MRM driver configuration (e.g., AC-coupling from driver 120 to both anode and cathode terminals of MRM 105). In FIG. 1, compensator 130 is included in device 101 to further improve driver matching network to account for the asymmetric configuration of driver 120 and circuit paths 161 and 162 coupling to MRM 105.

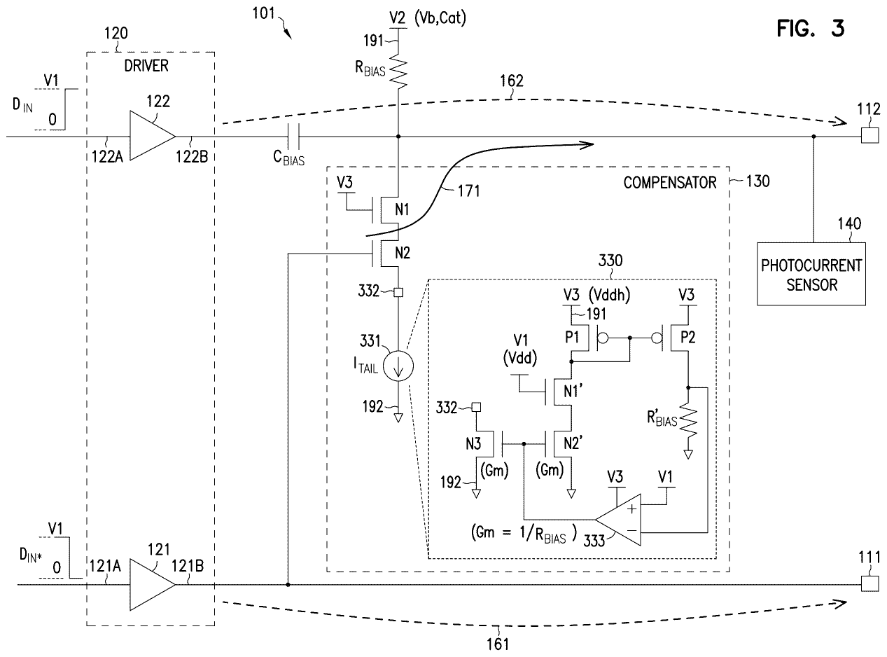

FIG. 3 shows device 101 including details of compensator 130, according to some embodiments described herein. For simplicity, description of the same elements between FIG. 1 and FIG. 3 (and other figures) are not repeated. As shown in FIG. 3, compensator 130 can include transistors N1 and N2, a current sink 331, and a circuit 330 including transistors N1′, N2′, N3, P1, and P2, resistor R′BIAS, and an operational amplifier (OpAmp) 333. Circuit 330 can be part of a feedforward circuit provided by compensator 130 to compensate BLW, as described below. Resistors R′BIAS can be a copy (e.g., a replica) of resistor R_{BIAS}. Transistor N3 can 330 be part of current sink 331 associated a current I_{TAIL}. As shown in FIG. 3, transistors N2 and N3 can be coupled to each other at a node 332. Transistors N1 and N2 and current sink 331 (which includes transistor N3) can be structured (e.g., can operate) as a current mode driver at node 112 (which is coupled to terminal (e.g., cathode terminal) 105B of MRM 105 of FIG. 1). Transistors N1, N2, N1′, N2′, and N3 can include n-type transistors (e.g., n-channel metal-oxide semiconductor (NMOS) transistors). Transistors P1 and P2 can include p-type transistors (e.g., p-channel metal-oxide semiconductor (PMOS) transistors). Transistors N1 and N2 can include a relatively thick gate oxide. Transistors N1 and N2 can be coupled in series (e.g., stack one over another) with node 112 to handle the relatively high operational voltage of the cathode bias voltage (e.g., voltage V2) at terminal 105B of MRM 105. The gate of transistor N1 can be coupled to voltage V3 to allow it to be turned on during the operation of driver 120. In the example of FIG. 3, the gate of transistor N2 can be coupled to output node 121B of driver circuit 121 to receive a signal based on signal D_{IN}*. However, the gate of transistor N2 can be coupled to a different node to receive a signal based on signal D_{IN}*. Transistor N2 can be part of a feedforward path 171 that provides BLW compensation for driver 120.

In FIG. 3, it is assumed that the current mode driver has constant transconductance Gₘ, driver 120 provides an ideal voltage source, and voltage V1 (Vpp) is the swing of signals (e.g., input data signals) D_{IN} and D_{IN}*. Then, gain of the current mode driver is

$${G}_{m} {V}_{pp} ( {R}_{BIAS} \vert \vert \frac{1}{s {C}_{BIAS}} ) = \frac{{R}_{BIAS} {G}_{m} {V}_{pp}}{s {R}_{BIASs} {C}_{BIAS} + 1} .$$

When Gₘ is 1/R_{BIAS}, the gain becomes

$$\frac{{V}_{pp}}{s {R}_{BIASs} {C}_{BIAS} + 1} ,$$

and the current mode driver recovers low-pass filtered data the same as the driver BLW and compensates it. Circuit 330 includes a replica (replica feedback loop) of the current mode driver to set Gₘ to be 1/R_{BIAS}. As shown in FIG. 3, the input of circuit 330 can be set to the value (e.g., a fixed value) of voltage V1 (e.g., Vdd=Vpp). Circuit 330 draws GₘVₚₚ current and it creates load voltage VₚₚGₘR_{bias} of circuit 330. This load voltage is feedbacked to be voltage V1 (Vₚₚ) at an input node of OpAmp 333. Thus, Gₘ is feedbacked to 1/R_{BIAS} consequently. Compensator 130 compensates BLW and allows lower R_{BIAS} or C_{BIAS} in the bias network design, which results in lower IR drop in reverse bias or lighter load to the driver.

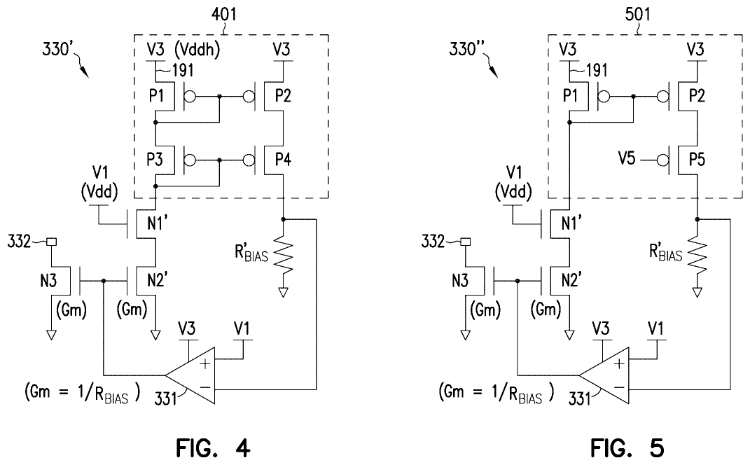

FIG. 4 and FIG. 5 show circuits 330′ and 330″ that can substitute circuit 330 of compensator 130 of FIG. 3, according to some embodiments described herein. As shown in FIG. 4, circuit 330′ includes the same elements as circuit 330 except for an addition of transistors P3 and P4 to form a cascoded current mirror 401. As shown in FIG. 5, circuit 330″ includes the same elements as circuit 330 except for an addition of transistor P5 (and a bias voltage V5) to form a cascoded current mirror 501. Circuits 330′ and 330″ can reduce current mirroring errors (e.g., improve linearity) across process corners. For example, the accuracy of the current mirroring inside the loop (e.g., replica feedback loop in circuit 330 in FIG. 3) can improve accuracy of current I_{TAIL}. Mismatch between the drain voltages of transistors P1 and P2 (FIG. 3) can lead to drain-induced barrier lowering (DIBL) that can cause mirroring mismatch across corners. Circuits 330′ and 330″ in FIG. 4 and FIG. 5, respectively, can minimize such a mismatch.

FIG. 6 shows device 101 including details of photocurrent sensor 140, according to some embodiments described herein. As shown in FIG. 6, device 101 can include resistors R1 and R2, an OpAmp 620, and a circuit 640. Circuit 640 includes a circuit 130′, which can be a copy (e.g., a replica) of compensator 130 (FIG. 3), such that circuit 130′ can include circuit elements similar to or the same as those of compensator 130. As shown in FIG. 6, circuit 640 can also include resistors R1′ and R2′, transistors N4, N5, and N6. Resistors R1′ and R2′ can be copies (e.g., replicas) of resistors R1 and R2, respectively. As shown in FIG. 6, photocurrent sensor 140 can include an input path (that includes resistor R1) coupled between node 112 on circuit path 162 (labeled in FIG. 3) and an input node (node “−”) of OpAmp 620. Photocurrent sensor 140 can include an input path (that includes resistor R1′) coupled between another input node (node “+”) of OpAmp 620 and the current path that includes transistors N4 and N5. The output node of OpAmp 620 is coupled to the gate of transistor N5.

In operation, photocurrent is sensed from the IR drop in voltage V_{CM} (common mode voltage) as shown in FIG. 6. Resistive voltage divider (formed by resistors R1 and R2) divides voltage V_{CM} by a factor of k. Divided voltage V_{CM} (k. V_{CM}) is compared with a divided voltage k. V_{CM, REP}. Voltage V_{CM, REP} is a copy (e.g., a replica) of voltage V_{CM}. In circuit 640, the circuit path between capacitor C_{BIAS} and conductive pad 112 (AC-coupled circuit path 162 in FIG. 2) is reproduced (e.g., replicated) without high-speed path. Transistor N5 can mimic the photocurrent source (current Iph) and generate a current Iph copy based on current Iph. Current Iph flows on a current path that include transistors N4 and N5. Current Iph, copy from transistor N5 is locked to current Iₚₕ by creating a feedback comparison loop based on voltage V_{CM}. The feedback loop enforces voltage V_{CM}=V_{CM, REP} at input nodes 621 and 622, respectively, of OpAmp 620, and consequently current Iph=Iph,copy. Transistors N5 and N6 can form a current mirror (current mirror network) to generate current I_{SENSE} at node 670 based on current Iph,copy. Current I_{SENSE} (sensed photocurrent) can be handled for thermal control loop for MRM or observability, or both.

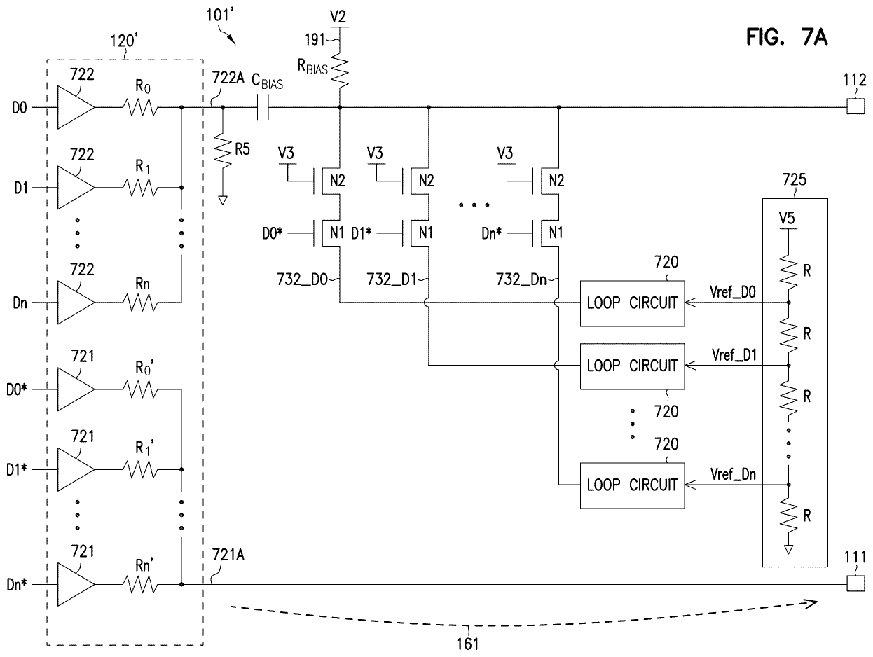

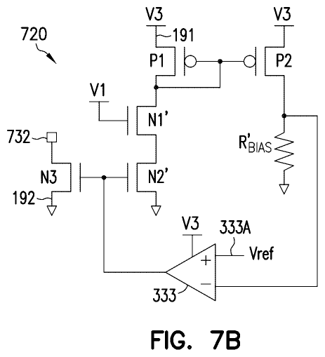

FIG. 7A shows a device 101′ including multiple data lanes that can be a variation of device 101 of FIG. 1, according to some embodiments described herein. FIG. 7B shows details of loop circuit 720 of FIG. 7A. As shown in FIG. 7A, device 101′ can include multiple data lanes (data paths) associated with signals (digital input data signals) D0 through Dn. The example in FIG. 7A shows an example of n+1 data lanes (n is an integer) in which each data lanes can include a driver circuit 722 and a respective resistor (one of resistors R₀ through Rn) that are coupled to a resistor R5 and the bias network (e.g., capacitor C_{BIAS} and resistor R_{BIAS}) of device 101′. Signals D0* through Dn* can be complementary signals of signals D0 through Dn, respectively. Signals D0 through Dn and D0* through Dn* are digital signals that can be similar to signals D_{IN} and D_{IN}*, respectively. Signals D0 through Dn can be part of a multi-level signaling configuration. An example of such multi-level signaling configuration includes Pulse-Amplitude Modulation 4-Level (PAM4) or other Pulse-Amplitude Modulation configurations.

As shown in FIG. 7A, device 101′ can include a driver 120′ that can include driver circuits 721 and 722 coupled to respective output nodes 721A and 722A of driver 120′. Driver circuits 721 are associated with signals D0* through Dn* to drive signals D0* through Dn* to conductive pad 111. Driver circuits 722 are associated with signals D0 through Dn to drive signals D0 through Dn to conductive pad 112.

As shown in FIG. 7A, device 101′ can include a resistor R5 and other elements that are similar to those of device 101 of FIG. 3, such as capacitor C_{BIAS}, R_{BIAS}, and transistors N1 and N2. Device 101′ also include circuit paths associated with signals D0* through Dn* that are coupled to conductive pad 111, which is coupled to the anode terminal (e.g., terminal 105A in FIG. 1) of modulator MRM 105. For simplicity, descriptions of similar or the same elements between FIG. 3 and FIG. 7A are not repeated.

In FIG. 7A, device 101′ can include loop circuits 720 coupled to respective pairs of transistors N1 and N2 at respective nodes 732_D0 through 732_Dn. Each pair of transistors N1 and N2 is associated with a respective data lane (e.g., associated with one of driver circuits 722 and one of resistors R₀ through Rn).

Device 101′ can include a voltage generator (e.g., reference voltage generator) 725 to generate voltages (e.g., reference voltages) Vref_D0 through Vref_Dn. Voltages Vref_D0 through Vref_Dn are provided to respective loop circuits 720. The levels of voltages Vref_D0 through Vref_Dn can be based on the levels of signals D0 through Dn, respectively. For example, the levels of voltages Vref_D0 through Vref_Dn can be based on a PAM4 signaling configuration.

As shown in FIG. 7B, loop circuit 720 includes elements (e.g., which form a current mode driver) similar to that of circuit 330 of FIG. 3. However, unlike FIG. 3, an input node 333A of OpAmp 333 receives a voltage Vref (instead of voltage V1). Input node 333A is coupled to voltage generator 725 of FIG. 7A, such that voltage Vref is one of voltages Vref_D0 through Vref_Dn. Node 732 of loop circuit 720 in FIG. 7B corresponds to one of nodes 732_D0 through 732_Dn of FIG. 7A. In FIG. 7A, loop circuits 720 and respective pairs of transistors N1 and N2 can operate to provide BLW compensation to respective data lanes of device 101′ in ways similar to that of compensator 130 of FIG. 3 providing BLW compensation to device 101 of FIG. 3.

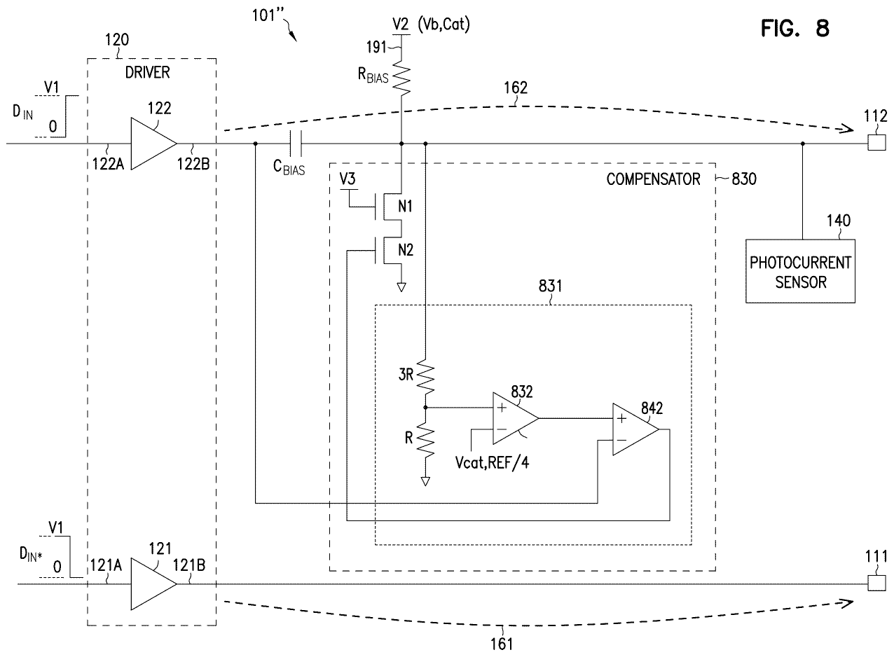

FIG. 8 shows a device 101″ including feedback-based BLW compensation, according to some embodiments described herein. Device 101″ can be a variation of device 101 of FIG. 1 and can include elements similar to (or the same as) the elements of device 101. Thus, for simplicity, descriptions of similar or the same elements between FIG. 3 and FIG. 8 are not repeated. Differences between devices 101 and 101″ include compensator 830, which can operate to provide feedback-based BLW compensation.

In operation, compensator 830 can operate to sense a difference in the signal at output node 122B (the signal before capacitor C_{BIAS}) and the signal at conductive pad 112 (the signal after capacitor C_{BIAS}). Based on the sensed signals (signals at output nodes 122B and conductive pad 112), compensator 830 can minimize the difference in these signals through circuit 831. Circuit 831 is part of a feedback network (e.g., feedback circuit) to provide feedback-based BLW compensation in device 101″.

As shown in FIG. 8, compensator 830 can include transistors N1 and N2, resistors R and 3R, and OpAmps 832 and 842. Transistors N1 and N2 can be similar to transistors N1 and N2 of compensator 130 of FIG. 3. Resistors R and 3R can form a resistor divider coupled to conductive path 112 to allow OpAmp 832 to be structured using relatively low-voltage devices (e.g., low voltage transistors). OpAmp 832 can be configured to have a gain of 4 to compensate the voltage divider formed by resistors R and 3R. As shown in FIG. 8, compensator 830 can include nodes (e.g., input nodes) coupled to respective nodes (e.g., plates) of capacitor C_{BIAS} (the nodes of capacitor C_{BIAS} that are coupled to output node 122B and conductive pad 112). Compensator 830 also includes a node (e.g., an output node) at the output of OpAmp 832 that is coupled to the gate of transistor N2.

In operation, OpAmp 832 can sense the signal at conductive pad 112 through the resistor divider (resistors R and 3R). As shown in FIG. 1, conductive pad 112 is coupled to terminal 105B (cathode terminal) of modulator MRM 105 in FIG. 1. In FIG. 8, the sensing operation by OpAmp 832 also allow compensator 830 to set the bias voltage of terminal 105B (cathode terminal) of modulator MRM 105 using Vcat,REF (e.g., one-fourth of Vcat, REF). OpAmp 842 can operate to compare signal D_{IN} and the signal at the cathode terminal (minus Vcat,REF) of modulator MRM 105 (based on the signal at the output node of OpAmp 832). Based on this comparison, OpAmp 842 can adjust the current provided by transistor N2 to maintain the target signal swing of signal Din at conductive pad 112 (which is also the signal at terminal 105B (cathode terminal) of modulator MRM 105 in FIG. 1). The feedback-based BLW compensation provided by compensator 830 can reduce the BLW of driver 120. FIG. 8 shows an example of a feedback-based BLW compensation applied to a data lane (e.g., the data lane associated with driver 120) of device 101″. However, feedback-based BLW compensation provided by compensator 830 can be applied to multi-level signaling configuration (e.g., multi-level signaling configuration of device 101′ of FIG. 7A).

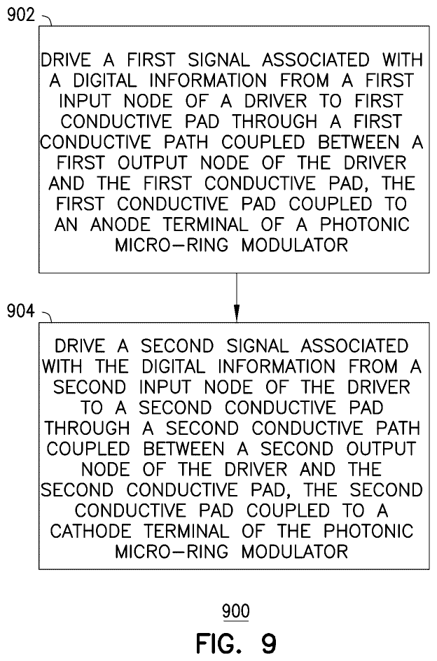

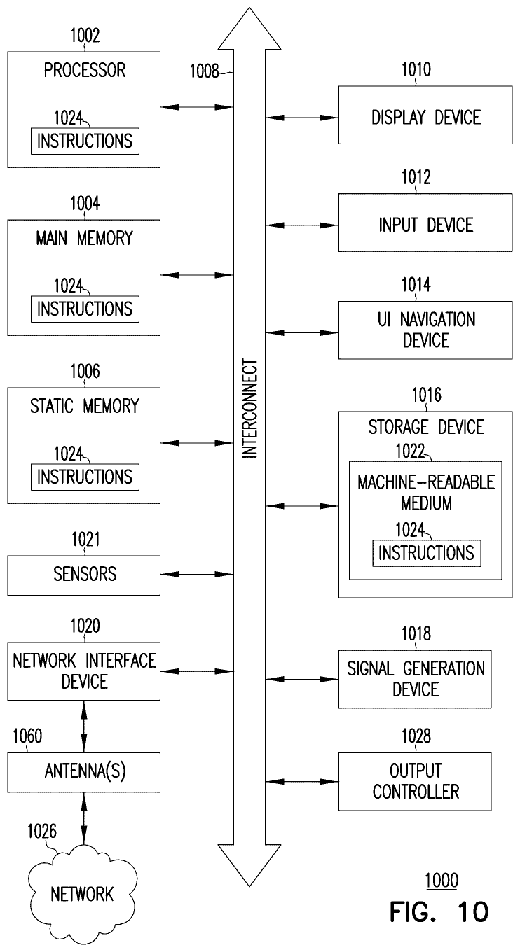

FIG. 9 is a flow diagram of an example method 900 of operating an apparatus, according to some embodiments described herein. The apparatus associated with method 900 can include apparatus 100 of FIG. 1. As shown in FIG. 9, method 900 can include operations 902 and 904, which may be executed by an embedded controller or another processor of a computing device (e.g., hardware processor 1002 of machine 1000 illustrated in FIG. 10, which can include one or more of the circuits discussed in connection with FIG. 1 through FIG. 8. In some embodiments, one or more of the circuits discussed in connection with FIG. 1 through FIG. 8 can perform the functionalities (e.g., operations) shown in FIG. 9 and in the examples listed below.

Operation 902 can include driving a first signal (e.g., signal D_{IN}) associated with digital information from a first input node of a driver (e.g., driver 120) to a first conductive pad (e.g., conductive pad 111) through a first conductive path (e.g., circuit path 161) coupled between a first output node of the driver and the first conductive pad, the first conductive pad coupled to an anode terminal of a photonic micro-ring modulator (e.g., MRM 105). Operation 904 can include driving a second signal (e.g., signal D_{IN}*) of the digital information from a second input node of a driver to a second conductive pad (e.g., conductive pad 112) through a second conductive path (e.g., circuit path 162) coupled between a second output node of the driver and the second conductive pad. The second conductive pad is coupled to a cathode terminal of the photonic micro-ring modulator. The first circuit path and the second circuit path include an unequal numbers of circuit elements.

Method 900 can include fewer or more operations than the operations shown in FIG. 9. For example, method 900 can include operations of apparatus 100 including operations of devices 101, 101′, and 101″. Method 900 can also include operations described in the examples listed below.

FIG. 10 shows a block diagram of an apparatus in the form of an example machine (e.g., an electronic system) 1000 upon which any one or more of the techniques (e.g., methodologies) discussed herein may perform. In alternative embodiments, the machine 1000 may operate as a standalone device or may be connected (e.g., networked) to other machines. In a networked deployment, machine 1000 may operate in the capacity of a server machine, a client machine, or both in server-client network environments. In an example, machine 1000 may function as a peer machine in a peer-to-peer (P2P) (or other distributed) network environment. The machine 1000 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is shown, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

The apparatus including machine 1000 may be configured to perform one or more of the methods and/or operations disclosed herein. The apparatus may be intended as a component of machine 1000 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

Machine (e.g., computer system) 1000 may include a hardware processor 1002 (e.g., a central processing unit (CPU), a graphics processing unit (GPU), a hardware processor core, or any combination thereof), a main memory 1004, and a static memory 1006, some or all of which may communicate with each other via an interconnect (e.g., bus) 1008. In some aspects, main memory 1004, static memory 1006, or any other type of memory (including cache memory) used by machine 1000 can be configured based on the disclosed techniques or can implement the disclosed memory devices.

Specific examples of main memory 1004 include Random Access Memory (RAM) and semiconductor memory devices, which may include, in some embodiments, storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 1000 may further include a display device 1010, an input device 1012 (e.g., a keyboard), and a user interface (UI) navigation device 1014 (e.g., a mouse). In an example, display device 1010, input device 1012, and UI navigation device 1014 may be a touchscreen display. The machine 1000 may additionally include a storage device (e.g., drive unit or another mass storage device) 1016, a signal generation device 1018 (e.g., a speaker), a network interface device 1020, and one or more sensors 1021, such as a global positioning system (GPS) sensor, compass, accelerometer, or other sensors. Machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, hardware processor 1002 and/or instructions 1024 may comprise processing circuitry and/or transceiver circuitry.

Storage device 1016 may include a machine-readable medium 1022 on which one or more sets of data structures or instructions 1024 (e.g., software) embodying or utilized by any one or more of the techniques or functions described herein can be stored. Instructions 1024 may also reside, completely or at least partially, within the main memory 1004, within static memory 1006, or hardware processor 1002 during execution thereof by machine 1000. In an example, one or any combination of hardware processor 1002, main memory 1004, static memory 1006, or storage device 1016 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

FIG. 10 shows the machine-readable medium 1022 as a single medium as an example. However, the term “machine-readable medium” may include a single medium or multiple media (e.g., a centralized or distributed database and/or associated caches and servers) configured to store instructions 1024.

The term “machine-readable medium” may include any medium that is capable of storing, encoding, or carrying instructions for execution by machine 1000 and that causes machine 1000 to perform any one or more of the techniques of the present disclosure or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

Instructions 1024 may further be transmitted or received over a communications network 1026 using a transmission medium via network interface device 1020 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 302.11 family of standards known as Wi-Fi®, IEEE 302.16 family of standards known as WiMax®), IEEE 302.8.4 family of standards, a Long Term Evolution (LTE) family of standards, a Universal Mobile Telecommunications System (UMTS) family of standards, peer-to-peer (P2P) networks, among others.

In an example, network interface device 1020 may include one or more physical jacks (e.g., Ethernet, coaxial, or phone jacks) or one or more antennas to connect to communications network 1026. In an example, network interface device 1020 may include a connector, in which the connector conforms with at least one of USB, High-Definition Multimedia Interface (HDMI), Thunderbolt, Peripheral Component Interconnect Express (PCIe), Universal Chiplet Interconnect Express (UCIe) Ethernet, and Fiber Optic specifications. In an example, network interface device 1020 may include one or more antennas 1060 to wirelessly communicate using at least one single-input multiple-output (SIMO), multiple-input multiple-output (MIMO), or multiple-input single-output (MISO) techniques. In some examples, network interface device 1020 may wirelessly communicate using multiple-user MIMO techniques. The term “transmission medium” shall be taken to include any intangible medium that can store, encode, or carry instructions for execution by machine 1000 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, examples that include the elements shown or described are also contemplated. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of an IC chip, a system (e.g., a system in the form of machine 1000, a system on chip, a system-in-package, a system-on-package, or a combination of these systems), a set of intercommunicating functional blocks, or similar, although the scope of the disclosure is not limited in this respect.

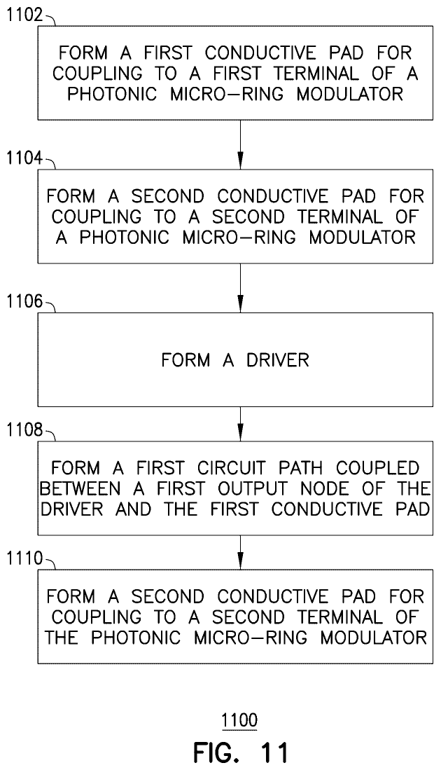

FIG. 11 is a flow diagram of an example process 1100 that includes a process of making an apparatus that includes a device and a driver, according to some embodiments described herein. The apparatus associated with process 1100 can include apparatus 100 of FIG. 1 or machine 1000 of FIG. 10. The device associated with process 1100 can include any of the devices and drivers (e.g., device 101, 101″, and 101″ and drivers 120 and 120′) described above with reference to FIG. 1 through FIG. 8.

As shown in FIG. 11, process 1100 can include activities 1102, 1104, 1106, 1108, and 1110. Activity 1102 can include forming a first conductive pad (e.g., conductive pad 111) for coupling to a first terminal (e.g., terminal 105A) of a photonic micro-ring modulator (e.g., MRM 105). Activity 1104 can include forming a second conductive pad (e.g., conductive pad 112) for coupling to a second terminal (e.g., terminal 105B) of the photonic micro-ring modulator. Activity 1106 can include forming a driver (e.g., driver 120). Activity 1108 can include forming a first circuit path (e.g., circuit path 161) coupled between a first output node of the driver and the first conductive pad. Activity 1110 can include forming a second circuit path (e.g., circuit path 162) coupled between a second output node of the driver and the second conductive pad.

Activities 1102, 1104, 1106, 1108, and 1110 can be performed in an order different from the order shown in FIG. 11. Process 1100 can include fewer or more operations than the operations shown in FIG. 11. For example, process 1100 can include forming other elements of the apparatus (e.g., the elements described above with reference to FIG. 1 through FIG. 8). Process 1100 can also include activities described in the examples listed below.

In the detailed description and the claims, the term “on” used with respect to two or more elements (e.g., materials), one “on” the other, means at least some contact between the elements (e.g., between the materials). The term “over” means the elements (e.g., materials) are in close proximity, but possibly with one or more additional intervening elements (e.g., materials) such that contact is possible but not required. Neither “on” nor “over” implies any directionality as used herein unless stated as such.

In the detailed description and the claims, the term “adjacent” generally refers to a position of a thing being next to (e.g., either immediately next to or close to with one or more things between them) or adjoining another thing (e.g., abutting it or contacting it (e.g., directly coupled to) it).

In the detailed description and the claims, the terms “first”, “second”, and “third,” etc. are used merely as labels, and are not intended to impose numerical requirements on their objects.

In the detailed description and the claims, a list of items joined by the term “at least one of” can mean any combination of the listed items. For example, if items A and B are listed, then the phrase “at least one of A and B” means A only; B only; or A and B. In another example, if items A, B, and C are listed, then the phrase “at least one of A, B and C” means A only; B only; C only; A and B (excluding C); A and C (excluding B); B and C (excluding A); or all of A, B, and C. Item A can include a single element or multiple elements. Item B can include a single element or multiple elements. Item C can include a single element or multiple elements.

In the detailed description and the claims, a list of items joined by the term “one of” can mean only one of the list items. For example, if items A and B are listed, then the phrase “one of A and B” means A only (excluding B), or B only (excluding A). In another example, if items A, B, and C are listed, then the phrase “one of A, B and C” means A only; B only; or C only. Item A can include a single element or multiple elements. Item B can include a single element or multiple elements. Item C can include a single element or multiple elements.

Described implementations of the subject matter can include one or more features, alone or in combination, as illustrated below by way of examples.

Example 1 is an electronic apparatus comprising a driver including a first input node to receive a first signal associated with digital information a first output node a second input node to receive a second signal associated with the digital information and a second output node, a first circuit path to couple the first output node of the driver to a first terminal of a photonic micro-ring modulator, and a second circuit path to couple the second output node of the driver to a second terminal of the photonic micro-ring modulator, wherein the first circuit path and the second circuit path include unequal numbers of circuit elements.

In Example 2, the subject matter of Example 1 includes subject matter wherein the first terminal of the photonic micro-ring modulator includes an anode terminal of the photonic micro-ring modulator, and the second terminal of the photonic micro-ring modulator includes a cathode terminal of the photonic micro-ring modulator.

In Example 3, the subject matter of Examples 1-2 includes subject matter wherein the second circuit path includes a capacitor coupled between the second output node of the driver and the second terminal of the photonic micro-ring modulator.

In Example 4, the subject matter of Example 3, further comprising a transistor coupled between the second capacitor node and a supply node.

In Example 5, the subject matter of Example 3, further comprising a transistor coupled between a first capacitor node of capacitor and a supply node, and a circuit, the circuit includes a first node coupled to the first capacitor node, a second node coupled to a second capacitor node of the capacitor, and a third node coupled to a gate of the transistor.

In Example 6, the subject matter of Example 3, further comprising a photocurrent sensor coupled to the second circuit path.

In Example 7, the subject matter of Examples 1-6 includes subject matter wherein each of the first signal and the second signal has a signal swing between a first voltage level and a second voltage level, wherein the first signal and the second signal swing in opposite directions between the first voltage level and the second voltage level.

In Example 8, the subject matter of Examples 1-7 includes subject matter wherein the driver includes a first additional input node to receive a first additional signal associated with an additional digital information, and a second additional input node to receive a second additional signal associated with the additional digital information.

In Example 9, the subject matter of Examples 1-8 includes subject matter wherein the apparatus comprises a system-on-chip (SoC), the SoC comprising the driver, the first circuit path, and the second circuit path.

In Example 10, the subject matter of Examples 1-8, further comprises an integrated circuit chip and at least one connector coupled to the integrated circuit chip, the integrated circuit chip including the driver, the first circuit path, and the second circuit path, and wherein the at least one connector conforms with at least one of Universal Serial Bus (USB), High-Definition Multimedia Interface (HDMI), Thunderbolt, Peripheral Component Interconnect Express (PCIe), Ethernet, Universal Chiplet Interconnect Express (UCIe), and Fiber Optic specifications.

Example 11 is an electronic apparatus comprising a driver including a first output node and a second output node, a first circuit path to couple the first output node of the driver to a first terminal of a photonic micro-ring modulator, a second circuit path to couple the second output node of the driver to a second terminal of the photonic micro-ring modulator, a transistor coupled between the second circuit path and a supply node, and one of a forward path including a current mode driver coupled to the transistor and a feedback path coupled to the transistor.

In Example 12, the subject matter of Example 11 includes subject matter wherein the current mode driver includes a current mirror coupled to the second circuit path.

In Example 13, the subject matter of Example 11 includes subject matter wherein the second circuit path includes a capacitor coupled between the second output node of the driver and the second terminal of the photonic micro-ring modulator, and the feedback path includes a first input node coupled to a first terminal of a capacitor on the second circuit path, a second input node coupled a second terminal of the capacitor, and an output node coupled to a gate of the transistor.

In Example 14, the subject matter of Example 11, further comprising an additional transistor coupled between the second circuit path and the supply node, and an additional current mode driver coupled to the additional transistor.

In Example 15, the subject matter of Examples 11-14 includes subject matter wherein the second circuit path has more circuit elements than the first circuit path.

In Example 16, the subject matter of Examples 11-15, further comprising a photocurrent sensor coupled to the second circuit path.

Example 17 is an electronic apparatus comprising a driver a first output node and a second output node, a first circuit path to couple the first output node of the driver to a first terminal of a photonic micro-ring modulator, a second circuit path to couple the second output node of the driver to a second terminal of the photonic micro-ring modulator, and a current sensor coupled to the second circuit path, the current sensor including a circuit to generate a first current based on a second current on the second circuit path, and to generate a sense current based on the first current.

In Example 18, the subject matter of Example 17 includes subject matter wherein the circuit of the sensor includes a current path to provide the first current, the current path including a transistor, an operational amplifier including an output node coupled to a gate of the transistor, a first input path coupled between the second circuit path and a first input node of operational amplifier, and a second input path coupled between the current path and a second input node of operational amplifier.

In Example 19, the subject matter of Example 17 includes subject matter wherein the circuit of the sensor includes a current mirror to generate the sense current based on the first current.

In Example 20, the subject matter of Examples 17-19, further comprising a transistor coupled between the second circuit path and a supply node, and a current mode driver coupled to the transistor.

Example 21 is a method of operating a driver, comprising driving a first signal associated with digital information from a first input node of a driver to a first conductive pad through a first conductive path coupled between a first output node of the driver and the first conductive pad, the first conductive pad coupled to an anode terminal of a photonic micro-ring modulator, and driving a second signal of the digital information from a second input node of a driver to a second conductive pad through a second conductive path coupled between a second output node of the driver and the second conductive pad, the second conductive pad coupled to a cathode terminal of the photonic micro-ring modulator, and the first circuit path and the second circuit path include an unequal numbers of circuit elements.

In Example 22, the subject matter of Example 21 includes subject matter wherein the second circuit path includes a capacitor, the capacitor includes a first capacitor node coupled to the second output node of the driver, and a second capacitor node coupled to the second conductive pad.

Example 23 is a process of making an electronic apparatus, comprising forming a first conductive pad for coupling to a first terminal of a photonic micro-ring modulator, forming a second conductive pad for coupling to a second terminal of the photonic micro-ring modulator, forming a driver, wherein the driver includes a first input node to receive a first signal associated with digital information, a first output node, a second input node to receive a second signal associated with the digital information, and a second output node, forming a first circuit path coupled between the first output node of the driver and the first conductive pad, and forming a second circuit path coupled between the second output node of the driver and the second conductive pad, wherein the first circuit path and the second circuit path include an unequal number of circuit elements.

In Example 24, the subject matter of Example 23 further comprising forming a capacitor including forming a first capacitor node coupled to the second output node of the driver, and a second capacitor node coupled to the second conductive pad.

In Example 25, the subject matter of Example 24, further comprising forming a transistor coupled between the second capacitor node and a supply node, and forming a connection between a gate of the transistor and the first output node of the driver.

Example 26 is an apparatus comprising at least one machine-readable medium including instructions that, when executed by processing circuitry, cause the processing circuitry to perform operations to implement any of Examples 1-22.

Example 27 is an apparatus comprising means to implement any of Examples 1-25.

Example 28 is a system to implement any of Examples 1-25.

Example 29 is a method to implement any of Examples 1-25.

The above description and the drawings illustrate some embodiments of the inventive subject matter to enable those skilled in the art to practice the embodiments of the inventive subject matter. Other embodiments may incorporate structural, logical, electrical, process, and other changes. Examples merely typify possible variations. Portions and features of some embodiments may be included in, or substituted for, those of others. Many other embodiments will be apparent to those of skill in the art upon reading and understanding the above description.

The Abstract is provided to allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a driver including:
a first input node to receive a first signal associated with digital information;
a first output node;
a second input node to receive a second signal associated with the digital information; and
a second output node;
a first circuit path to couple the first output node of the driver to a first terminal of a photonic micro-ring modulator; and
a second circuit path to couple the second output node of the driver to a second terminal of the photonic micro-ring modulator, wherein the first circuit path and the second circuit path include unequal numbers of circuit elements.

2. The apparatus of claim 1, wherein the first terminal of the photonic micro-ring modulator includes an anode terminal of the photonic micro-ring modulator, and the second terminal of the photonic micro-ring modulator includes a cathode terminal of the photonic micro-ring modulator.

3. The apparatus of claim 1, wherein the second circuit path includes a capacitor coupled between the second output node of the driver and the second terminal of the photonic micro-ring modulator.

4. The apparatus of claim 3, further comprising a transistor coupled between the second capacitor node and a supply node.

5. The apparatus of claim 3, further comprising:
a transistor coupled between a first capacitor node of capacitor and a supply node; and
a circuit, the circuit includes a first node coupled to the first capacitor node, a second node coupled to a second capacitor node of the capacitor, and a third node coupled to a gate of the transistor.

6. The apparatus of claim 3, further comprising a photocurrent sensor coupled to the second circuit path.

7. The apparatus of claim 1, wherein each of the first signal and the second signal has a signal swing between a first voltage level and a second voltage level, wherein the first signal and the second signal swing in opposite directions between the first voltage level and the second voltage level.

8. The apparatus of claim 1, wherein the driver includes:
a first additional input node to receive a first additional signal associated with an additional digital information; and
a second additional input node to receive a second additional signal associated with the additional digital information.

9. The apparatus of claim 1, wherein the apparatus comprises a system-on-chip (SoC), the SoC comprising the driver, the first circuit path, and the second circuit path.

10. The apparatus of claim 1, further comprises an integrated circuit chip and at least one connector coupled to the integrated circuit chip, the integrated circuit chip including the driver, the first circuit path, and the second circuit path, and wherein the at least one connector conforms with at least one of Universal Serial Bus (USB), High-Definition Multimedia Interface (HDMI), Thunderbolt, Peripheral Component Interconnect Express (PCIe), Ethernet, Universal Chiplet Interconnect Express (UCIe), and Fiber Optic specifications.

11. An apparatus comprising:
a driver including a first output node and a second output node;
a first circuit path to couple the first output node of the driver to a first terminal of a photonic micro-ring modulator;
a second circuit path to couple the second output node of the driver to a second terminal of the photonic micro-ring modulator;
a transistor coupled between the second circuit path and a supply node; and
one of a forward path including a current mode driver coupled to the transistor and a feedback path coupled to the transistor.

12. The apparatus of claim 11, wherein the current mode driver includes a current mirror coupled to the second circuit path.

13. The apparatus of claim 11, wherein:
the second circuit path includes a capacitor coupled between the second output node of the driver and the second terminal of the photonic micro-ring modulator; and
the feedback path includes a first input node coupled a first terminal of a capacitor on the second circuit path, a second input node coupled to a second terminal of the capacitor, and an output node coupled to a gate of the transistor.

14. The apparatus of claim 11, further comprising:
an additional transistor coupled between the second circuit path and the supply node; and
an additional current mode driver coupled to the additional transistor.

15. The apparatus of claim 11, wherein the second circuit path has more circuit elements than the first circuit path.

16. The apparatus of claim 11, further comprising a photocurrent sensor coupled to the second circuit path.

17. An apparatus comprising:
a driver a first output node and a second output node;
a first circuit path to couple the first output node of the driver to a first terminal of a photonic micro-ring modulator;
a second circuit path to couple the second output node of the driver to a second terminal of the photonic micro-ring modulator; and
a current sensor coupled to the second circuit path, the current sensor including a circuit to generate a first current based on a second current on the second circuit path, and to generate a sense current based on the first current.

18. The apparatus of claim 17, wherein the circuit of the sensor includes:
a current path to provide the first current, the current path including a transistor;
an operational amplifier including an output node coupled to a gate of the transistor;
a first input path coupled between the second circuit path and a first input node of operational amplifier; and
a second input path coupled between the current path and a second input node of operational amplifier.

19. The apparatus of claim 17, wherein the circuit of the sensor includes a current mirror to generate the sense current based on the first current.

20. The apparatus of claim 17, further comprising:
a transistor coupled between the second circuit path and a supply node; and
a current mode driver coupled to the transistor.
